(19) United States
(12) Patent Application Publication
(10) Pub. No.: US 2005/0077984 A1
(43) Pub. Date: Apr. 14, 2005

(54) Laminated low pass filter

(76) Inventors: Byoung Hwa Lee, Sungnam (KR); Jeong Ho Yoon, Sungnam (KR); Yong Sun Park, Hwasoon-gun (KR); Dong Seok Park, Seoul (KR); Sang Soo Park, Suwon (KR); Min Cheol Park, Anyang (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/735,616

(22) Filed: Dec. 16, 2003

(30) Foreign Application Priority Data
Oct. 8, 2003 (KR) 2003-69977

(51) Int. Cl. H01P 1/203

(52) U.S. Cl. 333/204

(57) ABSTRACT

A laminated low pass filter including a dielectric block having a plurality of laminated dielectric layers, input and output electrodes and outer ground electrodes formed on outer side surfaces of the dielectric block, so as to pass therethrough a signal inputted to the outer input electrode, only in a low frequency band, and then to output the passed signal to the outer output electrode. The laminated low pass filter also includes a transmission line including a distributed constant element made of a strip line formed on a first one of the dielectric layers, while being uniformly distributed with an inductance and a capacitance, the distributed constant element being connected between the input electrode and the output electrode, and a capacitor electrode structure having at least two layers while being connected between the input electrode and the output electrode. The capacitance electrode structure forms a capacitance connected in parallel to the transmission line. Since the laminated low pass filter is simply implemented by use of the transmission line and capacitors formed on the dielectric block having a multilayer structure, it can have a miniature size while exhibiting improved insertion loss characteristics, as compared to conventional laminated low pass filters implemented by use of concentrated constant elements.

### BACKGROUND OF THE INVENTION

1. Field of the Invention

The present invention relates to a laminated low pass filter, and more particularly to a laminated low pass filter which can be simply implemented by use of a transmission line and capacitors formed on a multi-layer substrate, so that it can have a miniature size while achieving an improvement in insertion loss characteristics.

2. Description of the Related Art

Generally, low pass filters are used to suppress spurious or harmonic components unnecessary in wireless communication systems such as cellular phones. These low pass filters are applied to a wireless communication system in order to pass a signal of a desired frequency, for example, a received signal or a signal to be transmitted, which is lower than a predetermined frequency and to remove signal components of a frequency band which are higher than the predetermined frequency, for example, harmonic or noise components. Regarding the characteristics of pass and reflection of a pass band in which a desired signal is included, a low pass filter should meet a specification required for the products to which it is applied.

Such a low pass filter may be configured in the form of a circuit using separate elements. Alternatively, such a low pass filter may be implemented in the form of a certain pattern on a laminated multilayer substrate structure. In recent years, laminated low pass filters, which may have a miniature size, have been widely used in accordance with miniaturization trend required for mobile communication systems.

FIG. 1 is a perspective view illustrating the outer structure of a conventional laminated low pass filter.

As shown in FIG. 1, the conventional laminated low pass filter, which is designated by the reference numeral 10, includes a dielectric block 10A having a substantially rectangular box shape. Input and output electrodes EIN and EOUT are formed at opposite longitudinal end surfaces of the dielectric block 10A, that is, front and rear surfaces, respectively. Also, outer ground electrodes EG are formed at opposite lateral end surfaces of the dielectric block 10A, that is, left and right surfaces. These outer electrodes are connected with inner electrodes not shown.

Non-contact electrodes ENC adapted to connect the inner electrodes are also formed at the left and right surfaces of the dielectric block 10A. Although not shown, inner ground electrodes are also provided within the dielectric block 10A. The inner ground electrodes are arranged at upper and lower portions of the dielectric block 10A. The input and output electrodes EIN and EOUT have a predetermined width while being insulated from the outer ground electrodes EG and inner ground electrodes.

FIG. 2 is a perspective view illustrating a laminated structure of the conventional laminated low pass filter.

As shown in FIG. 2, the conventional laminated low pass filter includes laminated layers LY1 to LY5. First, second and third ground electrodes G1, G2 and G3 are formed at the uppermost, intermediate and lowermost layers LY1, LY3 and LY5. In order to form an inductance for the low pass filter, first and second inductance patterns P11 and PL2 are formed at the layer LY2 interposed between the uppermost layer LY1 and the intermediate layer LY3. In order to form a capacitance for the low pass filter, first through fifth capacitance patterns PC1 to PC5 are formed at the layer LY4 interposed between the intermediate layer LY3 and the lowermost layer LY5.

The first and second inductance patterns PL1 and PL2 are formed on a single layer or formed on two layers, respectively, while having a spiral or meander shape in order to reduce its occupied area. The first and second inductance patterns PL1 and PL2 are connected to the input and output electrodes EIN and EOUT, respectively. Each of the first and second capacitance patterns PC1 and PC2 faces the ground electrode G2 to form a capacitance therebetween, whereas the third capacitance pattern PC3 faces the ground electrode G3 to form a capacitance therebetween. The first capacitance pattern PC1 also faces the fourth capacitance pattern PC4 to form a capacitance therebetween. The fifth capacitance pattern PC5 faces the third capacitance pattern PC3 to form a capacitance therebetween. Also, the second capacitance pattern PC2 faces the fourth capacitance pattern PC4 to form a capacitance therebetween.

Thus, the above mentioned conventional laminated low pass filter requires about 7 element patterns. In order to connect these element patterns, it is necessary to form non-contact electrodes at the outer surfaces of the dielectric block 10A.

FIGS. 3a and 3b are equivalent circuit diagrams of the conventional laminated low pass filter, respectively.

As shown in FIGS. 3a and 3b, the conventional laminated low pass filter is a low pass filter using a concentrated constant element, that is, a lumped constant element. In the circuit shown in FIG. 3a, inductances L1 and L2 are connected in series between input and output terminals IN and OUT. Grounded capacitances C1, C2, and C3 are coupled to an end of the inductance L1 connected to the input terminal IN, a node between the inductances L1 and L2, and an end of the inductance L2 connected to the output terminal OUT, respectively.

In order to maximize suppression of second and third harmonics, the circuit of FIG. 3b is used, which is modified from the circuit of FIG. 3a. FIG. 3b is an equivalent circuit diagram corresponding to the structure of FIG. 2.

In FIG. 3b, “L1” corresponds to the first inductance pattern PL1 of FIG. 2, “L2” the second inductance pattern PL2 of FIG. 2, “C1” the capacitance formed between the first capacitance pattern PC1 and the ground electrode G2 in FIG. 2, “C2” the capacitance formed between the second capacitance pattern PC2 and the ground electrode G2 in FIG. 2, “C3” the capacitance formed between the third capacitance pattern PC3 and the ground electrode G3 in FIG. 2, and “C4” the capacitance formed between the second and fourth capacitance patterns PC2 and PC4 in FIG. 2. Also, “C5” corresponds to the capacitance formed between the third and fifth capacitance patterns PC3, PC4 and PC5 and between the first and fourth capacitance patterns PC1 and PC4.

In the conventional low pass filter having the above mentioned configuration, the first and second inductance patterns PL1 and PL2 form an inductance L of the low pass filter, whereas the first through fifth capacitance patterns PC1 to PC5 form a capacitance C of the low pass filter. Thus, the low pass filter serves to pass therethrough a signal having a frequency less than a cut-off frequency determined by the inductance L and capacitance C.

FIG. 4 is a characteristic graph of the conventional laminated low pass filter.

FIG. 4 depicts the characteristics of the filter which is implemented to pass therethrough signals of a frequency band lower than about 3 GHz. Referring to FIG. 4, it can be seen that the pass characteristic S21 of the filter for a desired frequency band is not lower than about −0.4 dB in a frequency band of not more than 3.0 GHz, whereas the reflection characteristic S11 of the filter is not higher than about −10 dB in a frequency band of not more than 3.0 GHz.

Here, the pass characteristic S21 is considered to be superior as its level is closer to 0 dB at a desired frequency, whereas the reflection characteristic S11 is considered to be superior as its level is lower than the attenuation level required in a product to which the filter is applied.

However, the above mentioned conventional laminated low pass filter has a problem in that it exhibits degraded insertion loss characteristics because a number of pattern elements are used.

Furthermore, the conventional laminated low pass filter has a complex configuration, so that it is difficult to manage respective characteristics of the elements used in the filter. Also, there is a complexity in the manufacture of the laminated low pass filter. In particular, there is a limitation in miniaturizing the laminated low pass filter.

### SUMMARY OF THE INVENTION

The present invention has been made in view of the above mentioned problems, and an object of the invention is to provide a laminated low pass filter simply implemented by use of a transmission line and capacitors formed on a multi-layer substrate.

Another object of the invention is to provide a laminated low pass filter which can have miniaturized size while achieving an improvement in insertion loss characteristics, as compared to conventional laminated low pass filters implemented using concentrated constant elements.

In accordance with the present invention, these objects are accomplished by providing a laminated low pass filter comprising a dielectric block including a plurality of laminated dielectric layers, an input electrode, an output electrode, and outer ground electrodes, the electrodes being formed on outer side surfaces of the dielectric block, the laminated low pass filter being adapted to pass therethrough a signal inputted to the outer input electrode, only in a low frequency band, and then to output the passed signal to the outer output electrode, the laminated low pass filter further comprising: a transmission line including a distributed constant element made of a strip line formed on a first one of the dielectric layers, while being uniformly distributed with an inductance and a capacitance, the distributed constant element being connected between the input electrode and the output electrode; and a capacitor electrode structure having at least two layers while being connected between the input electrode and the output electrode, the capacitance electrode structure forming a capacitance connected in parallel to the transmission line.

Preferably, the capacitor electrode structure comprises: a first capacitor electrode formed on a second one of the dielectric layers arranged beneath the first dielectric layer, and connected at one end thereof to the input electrode; and a second capacitor electrode formed on a third one of the dielectric layers arranged beneath the second dielectric layer such that a predetermined capacitance is formed between the first and second capacitor electrodes.

Alternatively, the capacitor electrode structure may comprise: a first capacitor electrode formed on a second one of the dielectric layers arranged beneath the first dielectric layer; and a second capacitor electrode formed on a third one of the dielectric layers arranged beneath the second dielectric layer such that a predetermined capacitance is formed between the first and second capacitor electrodes, the second capacitor electrode including a capacitor electrode formed on the third dielectric layer at one side of the third dielectric layer, and connected at one end thereof to the input electrode, and a capacitor electrode formed on the third dielectric layer at the other side of the third dielectric layer in such a manner that it is separate from the capacitor electrode, while being connected at one end thereof to the output electrode.

### BRIEF DESCRIPTION OF THE DRAWINGS

The above objects, and other features and advantages of the present invention will become more apparent after reading the following detailed description when taken in conjunction with the drawings, in which:

FIG. 1 is a perspective view illustrating the outer structure of a conventional laminated low pass filter;

FIG. 2 is a perspective view illustrating a laminated structure of the conventional laminated low pass filter;

FIGS. 3a and 3b are equivalent circuit diagrams of the conventional laminated low pass filter, respectively;

FIG. 4 is a characteristic graph of the conventional laminated low pass filter;

FIG. 5 is a perspective view illustrating a laminated low pass filter according to the present invention;

FIG. 6 is a perspective view illustrating a laminated structure of the laminated low pass filter according to a first embodiment of the present invention;

FIG. 7 is a perspective view illustrating a laminated structure of the laminated low pass filter according to a second embodiment of the present invention;

FIGS. 8a and 8b are perspective views illustrating patterns of a transmission line according to the present invention, respectively;

FIGS. 9a and 9b are equivalent circuit diagrams of the laminated low pass filter according to the present invention; and

FIG. 10 is a characteristic graph of the laminated low pass filter according to the present invention.

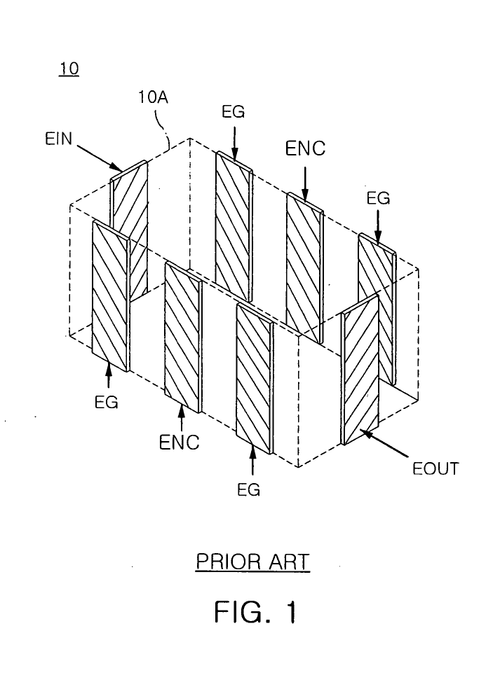

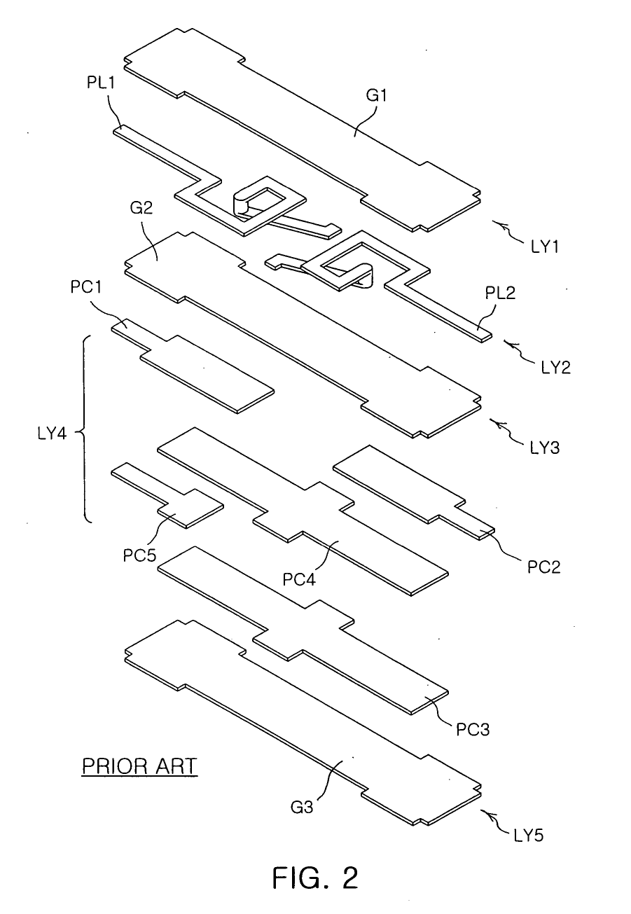

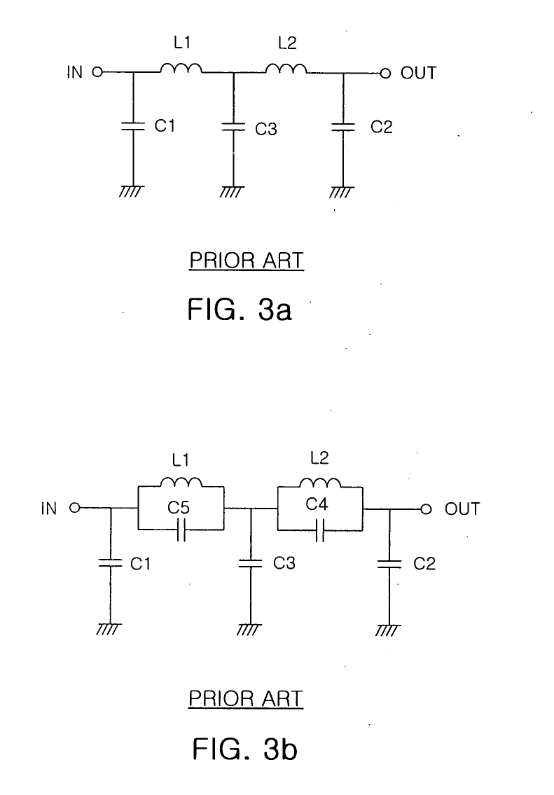

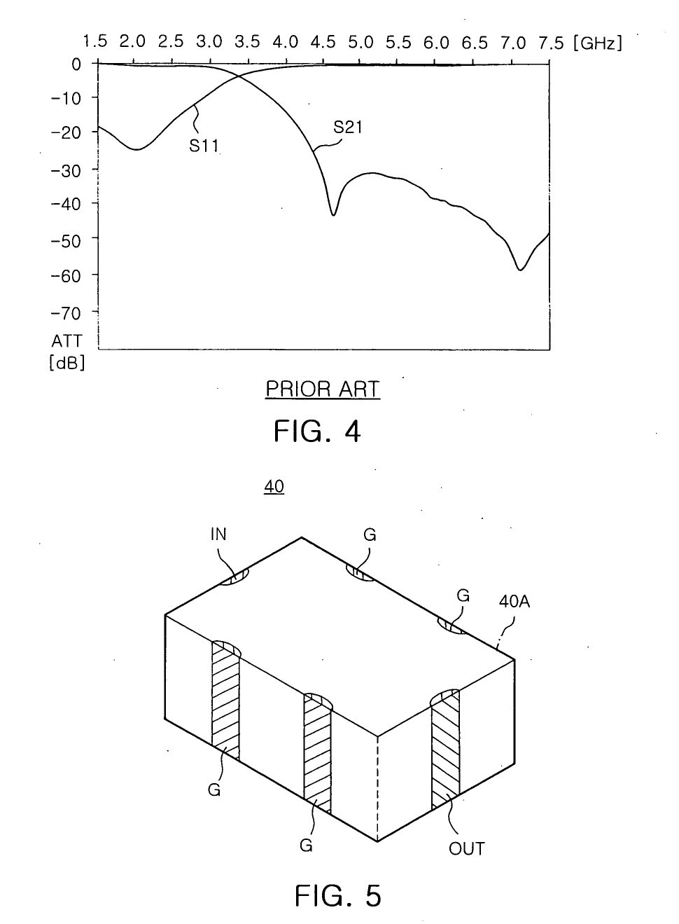

### DESCRIPTION OF THE PREFERRED EMBODIMENTS

Now, preferred embodiments of the present invention will be described in detail with reference to the annexed drawings.

In the drawings, constitutive elements having substantially the same configuration and function are designated by the same reference numeral.

FIG. 5 is a perspective view illustrating a laminated low pass filter according to the present invention.

Referring to FIG. 5, the laminated low pass filter of the present invention, which is designated by the reference numeral 40, includes a dielectric block 40A having a substantially rectangular box shape. Input and output electrodes IN and OUT, and ground electrodes G are formed at outer side surfaces of the dielectric block 40A such that they are connected to internal electrodes associated therewith, respectively.

The dielectric block 40A consists of a plurality of laminated dielectric layers. On the outer side surfaces of the dielectric block 40A having such a structure, the input electrode IN, output electrode OUT, and ground electrodes G are formed. In accordance with such a configuration, the laminated low pass filter of the present invention serves to pass therethrough a signal inputted to the outer input electrode IN, only in a low frequency band, and then to output the passed signal to the outer output electrode OUT. This laminated low pass filter includes a transmission line TRL. The transmission line TRL comprises a distributed constant element made of a strip line formed on a first one of the dielectric layers, that is, the uppermost dielectric layer, while being uniformly distributed with an inductance and a capacitance. The distributed constant element is connected between the input electrode IN and the output electrode OUT. The laminated low pass filter also includes a capacitor electrode structure connected between the input electrode IN and the output electrode OUT while forming a capacitance connected in parallel to the transmission line TRL.

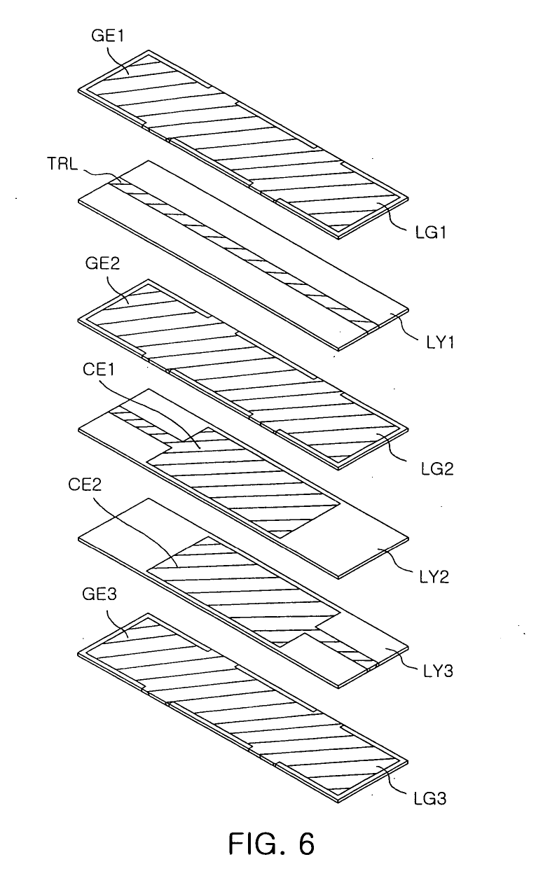

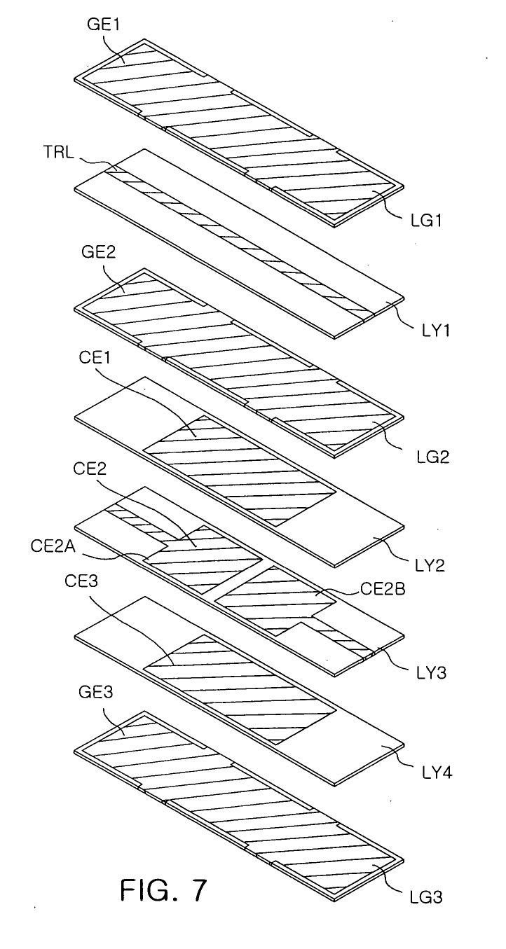

The capacitor electrode structure may be implemented in a variety of shapes. Typical capacitor electrode structures in accordance with the present invention will be described in detail with reference to FIGS. 6 and 7.

FIG. 6 is a perspective view illustrating a laminated structure of the laminated low pass filter according to a first embodiment of the present invention.

In the case of FIG. 6, the capacitor electrode structure includes a first capacitor electrode CE1 formed on the second dielectric layer LY2 arranged beneath the first dielectric layer LY1, and connected at one end thereof to the input electrode IN, and a second capacitor electrode CE2 formed on the third dielectric layer LY3 arranged beneath the second dielectric layer LY2 such that a capacitance C is formed between the first and second capacitor electrodes CE1 and CE2.

The laminated low pass filter also includes a first ground electrode GE1, a second ground electrode GE2, and a third ground electrode GE3. The first ground electrode GE1 is formed on a first ground layer LG1 laminated over the first dielectric layer LY1 at one side of the first ground layer LG1. The first ground electrode GE1 is connected with an associated one of the outer ground electrodes G. The second ground electrode GE2 is formed on a second ground layer LG2 interposed between the first and second dielectric layers LY1 and LY2 at one side of the second ground layer LG2. The second ground electrode GE2 is connected with an associated one of the outer ground electrodes G. The third ground electrode GE3 is formed on a third ground layer LG1 arranged beneath the third dielectric layer LY3 at one side of the third ground layer LG3. The third ground electrode GE3 is connected with an associated one of the outer ground electrodes G.

FIG. 7 is a perspective view illustrating a laminated structure of the laminated low pass filter according to a second embodiment of the present invention.

In the case of FIG. 7, the capacitor electrode structure includes a first capacitor electrode CE1 formed on the second dielectric layer LY2 arranged beneath the first dielectric layer LY1, and a second capacitor electrode CE2 formed on the third dielectric layer LY3 arranged beneath the second dielectric layer LY2 such that a capacitance C is formed between the first and second capacitor electrodes CE1 and CE2. The second capacitor electrode CE2 includes a capacitor electrode CE2A formed on the third dielectric layer LY3 at one side of the third dielectric layer LY3, and connected at one end thereof to the input electrode IN, and a capacitor electrode CE2B formed on the third dielectric layer LY3 at the other side of the third dielectric layer LY3 in such a manner that it is separate from the capacitor electrode CE2A, while being connected at one end thereof to the output electrode OUT.

The capacitor electrode structure may further include a third capacitor electrode CE3 formed on the fourth dielectric layer LY4 arranged beneath the third dielectric layer LY3 such that a capacitance is formed between the second and third capacitor electrodes CE2 and CE3.

The laminated low pass filter also includes a first ground electrode GE1 formed on a first ground layer LG1 laminated over the first dielectric layer LY1 at one side of the first ground layer LG1, while being connected with an associated one of the outer ground electrodes G, a second ground electrode GE2 formed on a second ground layer LG2 interposed between the first and second dielectric layers LY1 and LY2 at one side of the second ground layer LG2, while being connected with an associated one of the outer ground electrodes G, and a third ground electrode GE3 formed on a third ground layer LG1 arranged beneath the fourth dielectric layer LY4 at one side of the third ground layer LG3, while being connected with an associated one of the outer ground electrodes G.

As described above, the laminated low pass filter of the present invention uses the transmission line TRL corresponding to a distributed constant element, and the capacitance C formed between the first and second capacitor electrodes CE1 and CE2 corresponding to lumped constant elements. Accordingly, the laminated low pass filter of the present invention corresponds to a semi-lumped constant element.

The embodiments of capacitor electrode structures shown in FIGS. 6 and 7 are examples made only for illustrative purposes in association with the implementation of the capacitor electrode according to the present invention. The capacitor electrode of the present invention is not limited to the structure shown in FIG. 6 or 7, and may have a diverse structure in so far as the structure has a pattern capable of a desired capacitance connected in parallel to the transmission line.

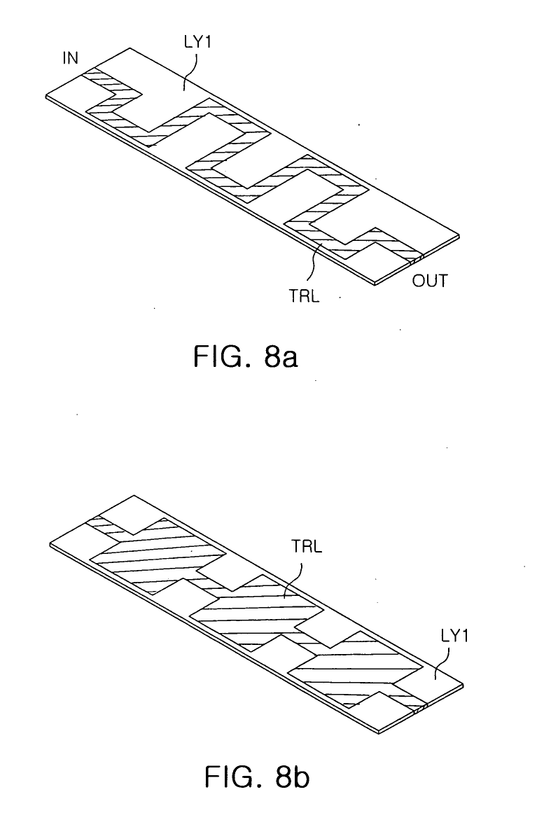

FIGS. 8a and 8b are perspective views illustrating patterns of the transmission line according to the present invention, respectively.

Referring to FIG. 8a, the transmission line TRL of the present invention may comprise a distributed constant element made of a meander-shaped strip line formed on the first dielectric layer LY1, while being uniformly distributed with an inductance and a capacitance. The distributed constant element is connected between the input electrode IN and the output electrode OUT.

Where the transmission line TRL has a meander-shaped strip line pattern, as in this case, it is possible to control the position of an attenuation pole formed at a particular frequency included in a rejection band, by varying the meander-shaped strip line pattern.

Referring to FIG. 8a, the transmission line TRL of the present invention may comprise a distributed constant element made of a stepped strip line formed on the first dielectric layer LY1, while being uniformly distributed with an inductance and a capacitance. The distributed constant element is connected between the input electrode IN and the output electrode OUT.

Where the transmission line TRL has a stepped strip line pattern, as in this case, it is possible to control the position of an attenuation pole formed at a particular frequency included in a rejection band, by varying the stepped strip line pattern.

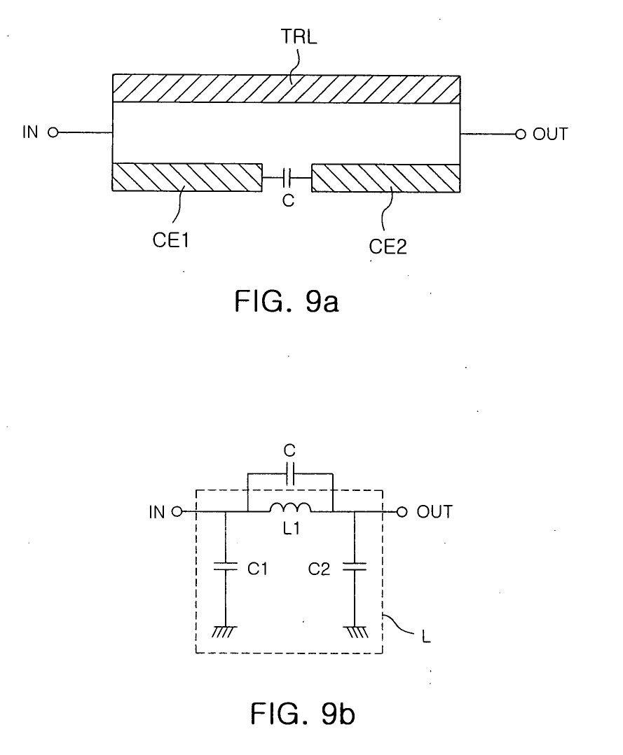

The circuit configuration of the laminated low pass filter according to the present invention is illustrated in FIG. 9a or 9b.

FIGS. 9a and 9b are equivalent circuit diagrams of the laminated low pass filter according to the present invention.

In FIG. 9a, “TRL” corresponds to the transmission line TRL of FIG. 6, “CE1” and “CE2” the first and second capacitor electrodes CE1 and CE2 of FIG. 6, and “C” the capacitance formed between the first and second capacitor electrodes CE1 and CE2 in FIG. 6. Thus, the circuit of FIG. 9a is equivalent to the low pass filter shown in FIG. 6.

In FIG. 9b, “C” corresponds to the first and second capacitor electrodes CE1 and CE2 of FIG. 6, whereas “C1”, “C2”, and “L1” form a circuit equivalent to the transmission line TRL shown in FIG. 6. In this case, the transmission line TRL is a distributed constant element uniformly distributed with a capacitance and an inductance. The equivalent circuit of the transmission line TRL is identical to a n type low pass filter, as shown in FIG. 9b.

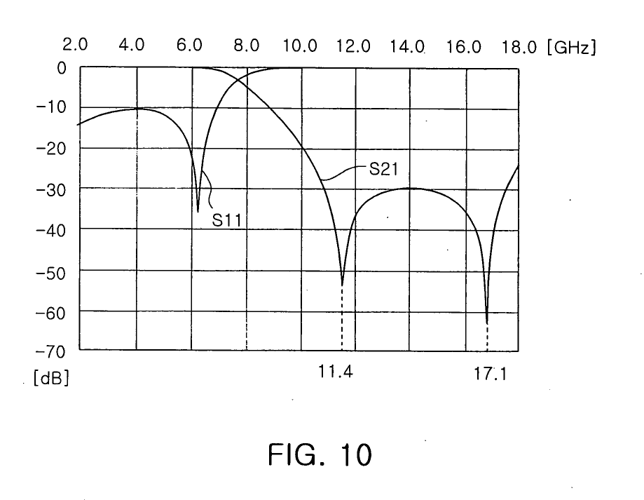

Referring to FIGS. 9a and 9b, it can be seen that the laminated low pass filter of the present invention operates as a low pass filter having superior characteristics. This low pass filter according to the present invention exhibits characteristics shown in FIG. 10.

FIG. 10 is a characteristic graph of the laminated low pass filter according to the present invention.

The characteristic graph of FIG. 10 depicts the characteristics of the laminated low pass filter in the case in which the filter is implemented to pass therethrough signals of a frequency band lower than about 5.7 GHz while rejecting harmonic components of frequencies other than 5.7 GHz. Referring to FIG. 10, it can be seen that the pass characteristic S21 of the filter is about 0.3 dB for a frequency band of not more than 6.0 GHz, whereas the reflection characteristic S11 of the filter is not higher than about −10 dB for a frequency band of not more than 6.0 GHz.

In accordance with the laminated low pass filter of the present invention, two attenuation poles are formed at frequencies of second and third harmonic components of 5.7 GHz, that is, at frequencies of about 11.4 GHz and about 17.1 GHz. Accordingly, it can be seen that it is possible to effectively attenuate harmonic components present in a high frequency band. The attenuation poles can be controlled by varying the pattern of the transmission line and capacitance C.

The above described laminated low pass filter of the present invention has a very simple configuration using a reduced number of elements, as compared to conventional laminated low pass filters, so that its insertion loss and attenuation characteristics are correspondingly improved.

As apparent from the above description, the present invention provides a laminated low pass filter which can be simply implemented by use of a transmission line and capacitors. By virtue of such a simple configuration, the laminated low pass filter can have a miniature size while exhibiting improved insertion loss characteristics, as compared to conventional laminated low pass filters implemented by use of concentrated constant elements.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A laminated low pass filter comprising a dielectric block including a plurality of laminated dielectric layers, an input electrode, an output electrode, and outer ground electrodes, the electrodes being formed on outer side surfaces of the dielectric block, the laminated low pass filter being adapted to pass therethrough a signal inputted to the outer input electrode, only in a low frequency band, and then to output the passed signal to the outer output electrode, the laminated low pass filter further comprising:
a transmission line including a distributed constant element made of a strip line formed on a first one of the dielectric layers, while being uniformly distributed with an inductance and a capacitance, the distributed constant element being connected between the input electrode and the output electrode; and
a capacitor electrode structure having at least two layers while being connected between the input electrode and the output electrode, the capacitance electrode structure forming a capacitance connected in parallel to the transmission line.

2. The laminated low pass filter according to claim 1, wherein the capacitor electrode structure comprises:
a first capacitor electrode formed on a second one of the dielectric layers arranged beneath the first dielectric layer, and connected at one end thereof to the input electrode; and
a second capacitor electrode formed on a third one of the dielectric layers arranged beneath the second dielectric layer such that a predetermined capacitance is formed between the first and second capacitor electrodes.

3. The laminated low pass filter according to claim 2, wherein the laminated low pass filter further comprises:
a first ground electrode formed on a first ground layer laminated over the first dielectric layer at one side of the first ground layer, the first ground electrode being connected with an associated one of the outer ground electrodes;
a second ground electrode formed on a second ground layer interposed between the first and second dielectric layers at one side of the second ground layer, the second ground electrode being connected with an associated one of the outer ground electrodes; and
a third ground electrode formed on a third ground layer arranged beneath the third dielectric layer at one side of the third ground layer, the third ground electrode being connected with an associated one of the outer ground electrodes.

4. The laminated low pass filter according to claim 1, wherein the capacitor electrode structure comprises:
a first capacitor electrode formed on a second one of the dielectric layers arranged beneath the first dielectric layer; and
a second capacitor electrode formed on a third one of the dielectric layers arranged beneath the second dielectric layer such that a predetermined capacitance is formed between the first and second capacitor electrodes, the second capacitor electrode including a capacitor electrode formed on the third dielectric layer at one side of the third dielectric layer, and connected at one end thereof to the input electrode, and a capacitor electrode formed on the third dielectric layer at the other side of the third dielectric layer in such a manner that it is separate from the capacitor electrode, while being connected at one end thereof to the output electrode.

5. The laminated low pass filter according to claim 4, wherein the capacitor electrode structure further comprises:
a third capacitor electrode formed on a fourth one of the dielectric layers arranged beneath the third dielectric layer such that a predetermined capacitance is formed between the second and third capacitor electrodes.

6. The laminated low pass filter according to claim 5, wherein the laminated low pass filter further comprises:
a first ground electrode formed on a first ground layer laminated over the first dielectric layer at one side of the first ground layer, while being connected with an associated one of the outer ground electrodes;
a second ground electrode formed on a second ground layer interposed between the first and second dielectric layers at one side of the second ground layer, while being connected with an associated one of the outer ground electrodes; and
a third ground electrode formed on a third ground layer arranged beneath the fourth dielectric layer at one side of the third ground layer, while being connected with an associated one of the outer ground electrodes.

7. The laminated low pass filter according to claim 1, wherein the distributed constant element is made of a meander-shaped strip line formed on the first dielectric layer while being uniformly distributed with an inductance and a capacitance.

8. The laminated low pass filter according to claim 1, wherein the distributed constant element is made of a stepped strip line formed on the first dielectric layer while being uniformly distributed with an inductance and a capacitance.
